(19) United States
(12) Patent Application Publication
(10) Pub. No.: US 2019/0162180 A1
(43) Pub. Date: May 30, 2019

(54) SYSTEM AND METHOD FOR DETECTING FAILURE OF A PRESSURE SENSOR IN A FIRE PUMP SYSTEM

(71) Applicant: TORNATECH INC., Montreal (CA)

(72) Inventors: MARC GOUPIL, ST-EUSTACHE (CA); FRANÇOIS HARVEY, MONTREAL (CA)

(21) Appl. No.: 15/827,355

(22) Filed: Nov. 30, 2017

(51) Int. Cl. F04B 51/00; A62C 37/50

(52) U.S. Cl. CPC F04B 51/00; A62C 35/68; A62C 37/50

(57) ABSTRACT

An automatic failure detecting device for detecting failure in a pressure sensor for a fire pump controller, the failure detecting device comprising a three-way valve connecting the pressure sensor to a water line, wherein when the three-way valve is activated, the pressure sensor is exposed to the atmosphere to measure the atmospheric pressure, and wherein the failure detection device signals a fault if said measured atmospheric pressure differs from a standard expected value.

### TECHNICAL FIELD

The present disclosure concerns automatic failure detection in a pressure sensor of a fire pump controller.

### BACKGROUND OF THE INVENTION

Fire pumps are needed when local municipal water systems, for example public underground water supplies, tanks, reservoirs and lakes, cannot provide sufficient pressure to meet the hydraulic design requirements of a fire sprinkler system. This usually occurs if a building is very tail, or if the system requires a relatively high terminal pressure at the fire sprinklers in order to provide large volumes of water, such as in storage warehouses. Fire pumps are also needed when the water supply is provided by a ground level water storage tank.

Fire pump controllers are usually equipped with a pressure sensor that is responsible for activating the pump in case of fire. The pressure sensor senses the water pressure in the sprinkler system's water line. In the event of a fire, the sprinkler system activates to spray water, thus lowering the water pressure in the water line. The fire pump controller is configured to activate the fire pump in the event that the pressure in the water line drops below an activation threshold, and to stop the pump when the water pressure rises above a stopping threshold. A proper working sensor is vital to the functioning of the fire system, and is thus a critical component.

Unfortunately, sensors have often been the subject of material or manufacturing problems. A noted defect is an offset in the response of the sensor under pressure, either downwards or upwards, while still maintaining the correct linearity of the response profile. Such a situation is dire, as a change in the response of a sensor can cause untimely activations of the pump, or worse, prevent its activation in the event of an actual pressure drop.

To resolve the above-mentioned problem, certain fire pump controllers have been equipped with a second redundant pressure sensor to corroborate the information provided by the main sensor. If the two readings are not the same, the system is notified. This technique suffers from certain drawbacks: there is a cost associated with adding a second sensor, and more importantly, it is extremely difficult to determine which of the two sensors is the faulty one.

### SUMMARY OF THE INVENTION

It is an object of the present disclosure to provide automatic failure detection in a pressure sensor for a fire pump controller that requires no additional redundant pressure sensor and allows for the detection of a faulty sensor with greater precision.

Accordingly, the present disclosure provides an automatic failure detecting device for detecting failure in a pressure sensor for a fire pump controller, the failure detecting device comprising a three-way valve connecting the pressure sensor to a water line, wherein when the three-way valve is activated, the pressure sensor is exposed to the atmosphere to measure the atmospheric pressure, and wherein the failure detection device signals a fault if said measured atmospheric pressure differs from a standard expected value.

There is also provided a method for automatically detecting failure in a pressure sensor for a fire pump controller, the method comprising the steps of exposing the pressure sensor to the atmosphere by activating a three-way valve connecting the pressure sensor to a water line, measuring an atmospheric pressure, comparing the measured atmospheric pressure to a standard expected value, and signaling a fault if the measured atmospheric pressure and the standard reading differ.

In an embodiment, the pressure sensor is exposed to the atmosphere once per day.

All of the foregoing and still further objects and advantages of the invention will become apparent from a study of the following specification, taken in connection with the accompanying drawings wherein like characters of reference designate corresponding parts throughout the several views.

### BRIEF DESCRIPTION OF THE FIGURES

Embodiments of the disclosure will be described by way of examples only with reference to the accompanying drawing, in which:

FIG. 1 is a graphical depiction of various pressure sensor response times;

FIG. 2A is a sketch of a failure detection device in an OFF state, in accordance with an illustrative embodiment of the present invention;

FIG. 2B is a sketch of a failure detection device in an ON state, in accordance with an illustrative embodiment of the present invention;

FIG. 3 is a graphical depiction of a pressure reading taken by the failure detection device of FIG. 2B, in accordance with an illustrative embodiment of the present invention; and

FIG. 4 is a schematic diagram of a fire pump controller system, in accordance with an illustrative embodiment of the present invention.

### DETAILED DESCRIPTION

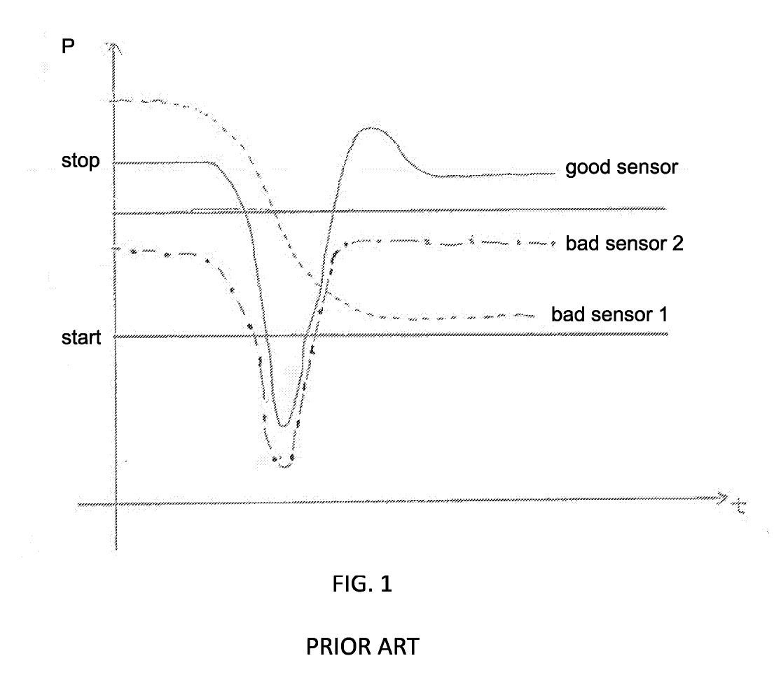

Referring to FIG. 1, there is shown a pressure-time graph for various pressure sensor readings in a typical fire pump system. For a properly functioning sensor, depicted by the curve “good sensor”, the pump motor is activated when the water pressure in the water line drops below a “start” value (due to the sprinkler system activating) and deactivates when the pressure in the water line rises back above a “stop” value, signifying that the sprinkler system is no longer being used and the pump has brought the water pressure up to a suitable value. For a faulty sensor with an upwardly offset pressure response, depicted by the curve “bad sensor 1”, a drop in pressure may never fall below the “start” value, and thus the motor will not activate in the case of a fire. In such a case, the water pressure will remain constant at a value lower than that required for the sprinkler system to be effective. Alternatively, for a faulty sensor with a downwardly offset pressure response, the pressure reading may drop low enough to initiate the pump, but never rise above the “stop value”, causing the pump to run continuously, eventually breaking. Therefore, it is thus crucial to ensure that the pressure sensor being used is providing accurate readings.

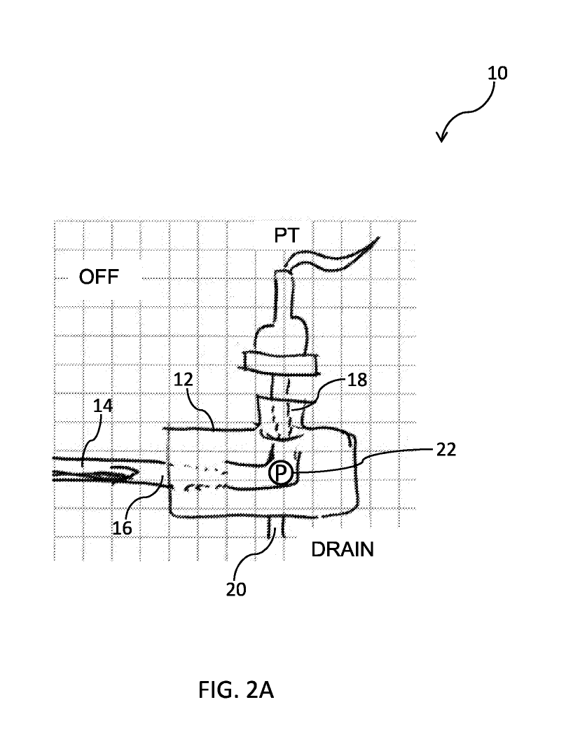

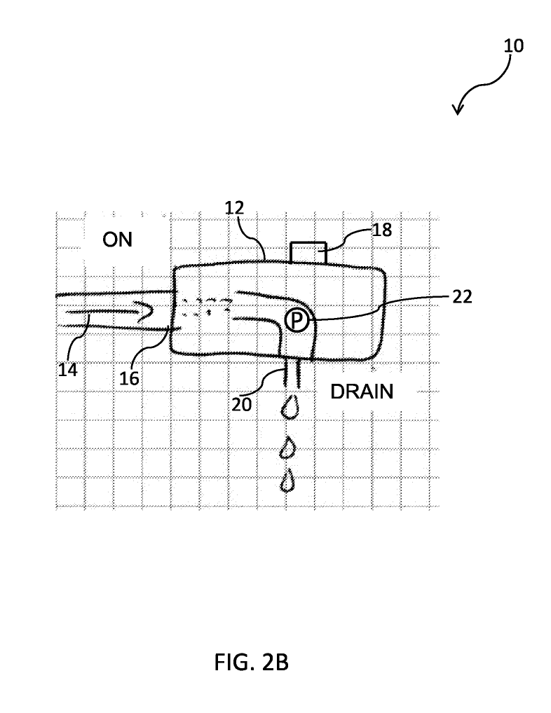

Referring now to FIG. 2A, there is shown a failure detection device, generally referred to by the reference numeral 10, in its OFF state. A three-way valve 12 positioned in the water line 14 replaces the standard valve (often a solenoid valve) typically found in fire pump controllers for creating a leak in the line of pressure to perform a start-up test. The three-way valve 12 comprises an inlet 16 for receiving water from the water line 14, a main outlet 18 directed towards the sprinkler system (not shown), a drain outlet 20 directed towards a drain (not shown), and a pressure sensor 22 or pressure transducer “PT”. In its OFF state, the three-way valve 12 directs water from the inlet 16 to the main outlet 18, and the pressure sensor 22 records the pressure of the water entering the failure detection device 10 from the water line.

Referring now to FIG. 2B, the failure detection device 10 is shown in its ON state. In this state, the three-way valve 12 is configured to direct water from the water line 14 entering the failure detection device 10 from the inlet 16 to the drain outlet 20 rather than the main outlet 18. In this configuration, the pressure sensor 22 is disconnected from the water line 14 and exposed to the atmosphere. Thus, the pressure sensor 20 may record pressure readings at atmospheric pressure.

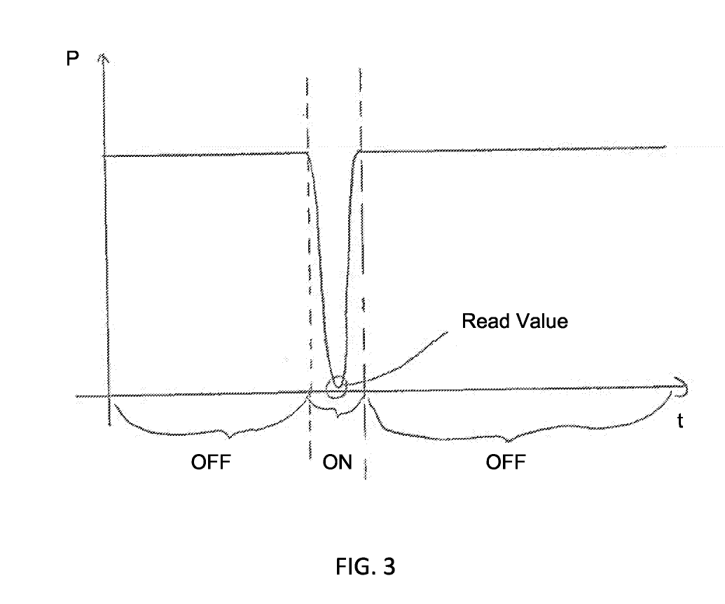

Referring now to FIG. 3 in addition to FIGS. 2A and 2B, a pressure-time graph displays pressure readings for various states of the failure detection device 10. During the OFF states, the pressure sensor 22 reads the pressure of the water passing through the failure detection device 10 from the main line 14, which remains consistent as long as the sprinkler system (not shown) is not activated. During the ON state, the pressure sensor 22 is exposed to the atmosphere, and thus records the atmospheric pressure. In an embodiment, the pressure sensor 22 is calibrated to read 0 PSI at atmospheric pressure. As such, in order to periodically test the accuracy of the pressure sensor 22, the failure detection device 10 is switched to its ON state by activating the three-way valve 12 and exposing the pressure sensor 22 to the atmosphere. If the pressure sensor 22 provides a reading of 0 PSI, then it is functioning properly. If the pressure sensor 22 does not provide a reading of 0 PSI, then failure has been detected and the faulty pressure sensor 22 may be replaced. In an embodiment, this test is performed daily or weekly to ensure constant surveillance of the pressure sensor.

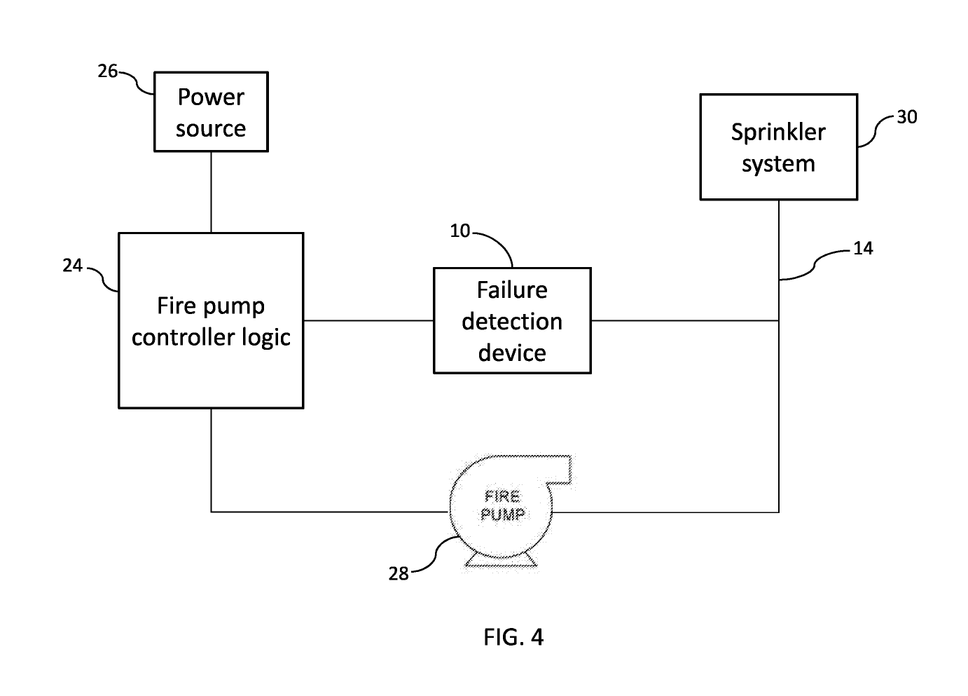

Referring now to FIG. 4, the failure detection device 10 is connected to a fire pump controller logic 24. Receiving power from a power source 26, the fire pump controller logic receives input from the failure detection device 10 regarding the water pressure in the water line 14. The fire pump controller 24 activates a fire pump 28 when a drop in pressure in the water line 14 is detected due to activation of a sprinkler system 30. When the failure detection device 10 detects failure in the pressure sensor (not shown), it alerts the fire pump controller logic 22.

The scope of the claims should not be limited by the preferred embodiments set forth in the examples, but should be given the broadest interpretation consistent with the description as a whole.

1. An automatic failure detecting device for detecting failure in a pressure sensor for a fire pump controller, the failure detecting device comprising a three-way valve connecting the pressure sensor to a water line, wherein when said three-way valve is activated, the pressure sensor is exposed to the atmosphere to measure the atmospheric pressure, and wherein the failure detection device signals a fault if said measured atmospheric pressure differs from a standard expected value.

2. A method for automatically detecting failure in a pressure sensor for a fire pump controller, the method comprising the steps of:
exposing the pressure sensor to the atmosphere by activating a three-way valve connecting the pressure sensor to a water line;
measuring an atmospheric pressure;
comparing said measured atmospheric pressure to a standard expected value; and
signaling a fault if said measured atmospheric pressure and said standard reading differ.

3. The method of claim 2, wherein the pressure sensor is exposed to the atmosphere once per day.
